(19) United States
(12) Patent Application Publication
(10) Pub. No.: US 2024/0243825 A1
(43) Pub. Date: Jul. 18, 2024

(54) PATHLOSS MEASUREMENT ON UNLICENSED SPECTRUM

(71) Applicant: Nokia Technologies Oy, Espoo (FI)

(72) Inventors: Sami-Jukka HAKOLA, Oulu (FI); Kari Juhani HOOLI, Oulu (FI); Jorma Johannes KAIKKONEN, Oulu (FI); Esa Tapani TIIROLA, Oulu (FI)

(21) Appl. No.: 18/574,197

(22) PCT Filed: Aug. 5, 2021
(86) PCT No.: PCT/EP2021/071900

§ 371 Date: Dec. 26, 2023

(51) Int. Cl. H04B 17/309; H04W 16/14; H04W 24/08

(52) U.S. Cl. CPC H04B 17/347; H04W 16/14; H04W 24/08

(57) ABSTRACT

There are provided measures for enabling/realizing pathloss measurement on an unlicensed spectrum, i.e. arrangement of an appropriate pathloss reference signal for operation on an unlicensed spectrum. Such measures exemplarily comprise that a communication node or element in a communication system, which is configured for beam-based operation on an unlicensed band, obtains a pathloss measurement configuration, including a reference signal for pathloss measurement, validates practicability of pathloss measurement based on the configured reference signal, and controls pathloss measurement, wherein pathloss is measured based on the configured reference signal in a case where the configured reference signal is practicable, or pathloss measurement is skipped or pathloss is measured based on another reference signal being on the same quasi-co-location chain as the configured reference signal in a case where the configured reference signal is not practicable.

### FIELD

The present disclosure relates to pathloss measurement on an unlicensed spectrum. More specifically, the present disclosure relates to measures/mechanisms (including methods, apparatuses (i.e. devices, entities, elements and/or functions) and computer program products) for enabling/realizing pathloss measurement on an unlicensed spectrum, i.e. arrangement of/for an appropriate pathloss reference signal for operation on an unlicensed spectrum.

### BACKGROUND

Basically, the present disclosure relates to pathloss measurement in a beam-based (mobile/wireless) communication system operating on an unlicensed spectrum (i.e. frequency range or band), such as 5G/NR systems and next generation systems beyond 5G (i.e. 6G, 7G, . . . ), including a relay/relaying scenario, environment or deployment, such as an IAB scenario, environment or deployment.

Mobile/wireless communication systems, e.g. 3GPP-standardized mobile/wireless communication systems, such as a 5G/NR system or next generations beyond 5G (i.e., 6G, 7G, . . . ), can exhibit extended operation to an unlicensed spectrum, such as the 60 GHz band or the frequencies between 52.6 GHz and 71 GHz. For such unlicensed operation, specific channel access mechanisms, shared spectrum operations, etc. are to be defined.

In 5G/NR/NR-U systems, channel access modes with and without LBT, i.e. channel sensing, may be supported. Herein, a channel access mode based on LBT is basically assumed, wherein a transmitter is required to perform LBT based on energy detection to initiate channel occupancy or channel occupancy time (COT). Herein, channel occupancy or channel occupancy time (COT) refers to channel occupation for transmission, e.g. by a serving communication control element or function such as a gNB.

It is to be noted that, due to the required channel sensing, which may also lead to a restriction of allowable transmission to certain spatial directions, LBT introduces uncertainty to transmission, which is also or even particularly relevant for periodic signals like (periodic) reference signals. Hence, the application of LBT may lead to performance degradation in any operations being based on such (periodic) reference signals, like e.g. pathloss measurement, as explained below.

For 5G/NR/NR-U systems, support for Short Control Signaling (SCS) is defined via its introduction into ETSI harmonized standard EN 302 567, the requirements of which are to be fulfilled. Short control signals, as defined by ETSI, are control and/or management transmissions that are not required to undergo channel sensing, i.e. LBT, but can instead be transmitted without channel sensing, as long as the total duration of SCS transmissions over a 100-ms observation interval does not exceed 10%.

Herein, when reference is made to SCS, this is to be more generally understood as contention (i.e. LBT) exempt transmission (of one or more control and/or management signals, resource, etc.).

Accordingly, there are specific rules for contention (i.e. LBT) exempt short control signaling, and it is agreed that such rules can be applicable to certain transmissions in 5G/NR/NR-U systems as well. Specifically, it is agreed that such rules are applicable to transmission of SSB (i.e. SS/PBCH block), and that other DL signals and/or channels might also be transmitted using such rules, e.g. CSI-RS.

Generally, pathloss measurements, e.g. in 5G/NR/NR-U systems, are expedient or even needed for beam and/or topology management. Namely, pathloss measurements are made for compensating for varying signal route conditions, which may be due to a moving UE (in a dynamic scenario) and/or moving obstacles (in a dynamic or static scenario).

For pathloss measurement in 5G/NR/NR-U systems, a base station entity, such as a gNB, provides a user equipment entity, such as a UE, with a pathloss measurement configuration, especially a pathloss reference signal (RS) to be used. With a measurement based on such pathloss reference signal, i.e. channel measurement for pathloss calculation/estimation, the UE can calculate a pathloss or a pathloss estimate between the gNB and UE, which is to be used in transmit power control for different UL signals and/or channels. The pathloss reference signal is provided for each UL signal and/or channel, and can be either SSB or CSI-RS.

If the UE is configured with a number of RS resource indexes, up to the value of maxNrofPUSCH-PathlossReferenceRSs, and a respective set of RS configurations for the number of RS resource indexes by PUSCH-PathlossReferenceRS, the set of RS resource indexes can include one or both of a set of SS/PBCH block (SSB) indexes, each provided by ssb-Index when a value of a corresponding pusch-PathlossReferenceRS-Id maps to a SS/PBCH block (SSB) index, and a set of CSI-RS resource indexes, each provided by csi-RS-Index when a value of a corresponding pusch-PathlossReferenceRS-Id maps to a CSI-RS resource index. The UE identifies a RS resource index in the set of RS resource indexes to correspond either to a SS/PBCH block (SSB) index or to a CSI-RS resource index as provided by pusch-PathlossReferenceRS-Id in PUSCH-PathlossReferenceRS.

In view of the above, there may be problems in pathloss measurement on an unlicensed spectrum, especially for beam-based systems operating on unlicensed band requiring LBT and using beam management utilizing periodic reference signals. Stated in other words, there may be problems in the arrangement of/for a periodic reference signal used in beam management.

On the one hand, it is problematic that the total duration of contention (i.e. LBT) exempt short control signals is restricted and CSI-RS may be excluded (by specification or configuration) from short control signal transmissions (e.g. unlike SSB). If so, CSI-RS transmissions are confined to gNB COTs only.

On the other hand, CSI-RS can be used for pathloss measurement used in transmit power control for a beam that can differ from a SSB beam. The accuracy of calculating a pathloss or a pathloss estimate and, hence, transmit power control may degrade when the gNB has not initiated a COT containing CSI-RS for some time.

Accordingly, CSI-RS may not be present (available) or valid for pathloss measurement, potentially in contrast to a provided pathloss measurement configuration for some UL signal and/or channel. Then, pathloss measurement and, thus, transmit power control for this UL signal and/or channel is not feasible.

Therefore, there is room for improvement and a desire/need for a technique for (enabling/realizing) pathloss measurement on an unlicensed spectrum, i.e. arrangement of/for an appropriate pathloss reference signal for operation on an unlicensed spectrum.

### SUMMARY

Various exemplifying embodiments of the present disclosure aim at addressing at least part of the above issues and/or problems and drawbacks.

Various aspects of exemplifying embodiments of the present disclosure are set out in the appended claims.

According to an example aspect of the present disclosure, there is provided a method of (or, stated in other words, operable or for use in/by) a communication node or element in a communication system, which is configured for beam-based operation on an unlicensed spectrum, comprising obtaining a pathloss measurement configuration, including a reference signal for pathloss measurement, validating practicability of pathloss measurement based on the configured reference signal, and controlling pathloss measurement, wherein pathloss is measured based on the configured reference signal in a case where the configured reference signal is practicable, or pathloss measurement is skipped or pathloss is measured based on another reference signal being on the same quasi-co-location chain as the configured reference signal in a case where the configured reference signal is not practicable.

According to an example aspect of the present disclosure, there is provided an apparatus of (or, stated in other words, operable or for use in/by) a communication node or element in a communication system, which is configured for beam-based operation on an unlicensed spectrum, comprising at least one processor and at least one memory including computer program code, wherein the processor, with the at least one memory and the computer program code, is configured to cause the apparatus to perform: obtaining a pathloss measurement configuration, including a reference signal for pathloss measurement, validating practicability of pathloss measurement based on the configured reference signal, and controlling pathloss measurement, wherein pathloss is measured based on the configured reference signal in a case where the configured reference signal is practicable, or pathloss measurement is skipped or pathloss is measured based on another reference signal being on the same quasi-co-location chain as the configured reference signal in a case where the configured reference signal is not practicable.

According to an example aspect of the present disclosure, there is provided an apparatus of (or, stated in other words, operable or for use in/by) a communication node or element in a communication system, which is configured for beam-based operation on an unlicensed spectrum, comprising means or circuitry for obtaining a pathloss measurement configuration, including a reference signal for pathloss measurement, means or circuitry for validating practicability of pathloss measurement based on the configured reference signal, and means or circuitry for controlling pathloss measurement, wherein pathloss is measured based on the configured reference signal in a case where the configured reference signal is practicable, or pathloss measurement is skipped or pathloss is measured based on another reference signal being on the same quasi-co-location chain as the configured reference signal in a case where the configured reference signal is not practicable.

According to various developments/modifications, any one of the aforementioned method-related and/or apparatus-related example aspects of the present disclosure may include one or more of the following features:
validating comprises: checking presence of the configured reference signal, wherein the configured reference signal is practicable when being present, and/or checking validity of the configured reference signal, wherein the configured reference signal is practicable when being valid,
checking presence yields that the configured reference signal is present when an indication is obtained, which indicates that the configured reference signal is part of short control signaling, and/or an indication is obtained, which indicates that the configured reference signal is within a served beam,
the indication, which indicates that the configured reference signal is within the served beam, comprises an indication, which indicates that at least one reference signal providing a quasi-co-location assumption of a channel occupancy time of a serving communication control node or element is earlier on the same quasi-co-location chain as the configured reference signal or has the same quasi-co-location chain as the configured reference signal,
the indication, which indicates that the configured reference signal is within the served beam, is based on detection of a physical downlink control channel with a demodulation reference signal on the same quasi-co-location chain as the configured reference signal, and/or content of downlink control information on a physical downlink control channel,
checking validity yields that the configured reference signal is valid when the configured reference signal has or relates to a downlink or flexible resource,
the method, functionality or operability further comprises obtaining a channel occupancy time configuration of a serving communication control node or element, relating to one or more reference signals, wherein validating comprises checking correspondence of the configured reference signal with the one or more reference signals, and the configured reference signal is practicable when corresponding to at least one of the one or more reference signals,
the channel occupancy time configuration comprises: a quasi-co-location assumption of a channel occupancy time of the serving communication control node or element, and/or an indication of one or more additional reference signals which are spatially correlated with at least one reference signal providing the quasi-co-location assumption,
the indicated one or more additional reference signals comprise one or more channel state information reference signals and/or comprise or are contained in one or more blocks of a synchronization signal and/or a physical broadcast channel,
checking comprises: checking whether the configured reference signal is among the one or more reference signals, including the at least one reference signal providing the quasi-co-location assumption and the indicated one or more additional reference signals,
when the configured reference signal is among the one or more reference signals, the pathloss is measured based on the configured reference signal using at least one of: the at least one reference signal providing the quasi-co-location assumption, the indicated one or more additional reference signals, and reference signals sharing the same quasi-co-location assumption in the channel occupancy time of the serving communication control node or element,
in a case where the configured reference signal is not practicable pathloss is measured based on the another reference signal when at least one condition is met, and pathloss measurement is skipped when the at least one condition is not met,
the at least one condition comprises one or more of: the another reference signal occurs within a predetermined period relative to an occasion of the configured reference signal, and there is no pathloss measurement based on the configured reference signal for a predetermined period,
for pathloss measurement based on the another reference signal, a higher layer filter configuration is used for filtering a received power of the another reference signal to be used in pathloss estimate calculation, which is different from the higher layer filter configuration in the obtained pathloss measurement configuration, and/or a value of an offset of transmission power of the configured reference signal relative to transmission power of the another reference signal is used for determining a reference signal power to be used in pathloss estimate calculation,
the method, functionality or operability further comprises detecting a channel occupancy time of a serving communication control node or element, wherein validating and controlling are performed in or for the detected channel occupancy time of the serving communication control node or element,
the method, functionality or operability further comprises calculating a pathloss estimate between the communication node or element and a serving communication control node or element based on the pathloss measurement, and specifying a transmission power for an uplink signal and/or channel based on the calculated pathloss estimate.
the configured reference signal is a channel state information reference signal,
the another reference signal is or is contained in a block of a synchronization signal and/or a physical broadcast channel,
the quasi-co-location chain relates to a channel occupancy time of a serving communication control node or element and/or comprises a quasi-co-location assumption of a channel occupancy time of a serving communication control node or element,
the communication node or element comprises or represents at least part of a user equipment entity or an integrated access and backhaul node or element or a mobile termination part entity,
the communication system comprises or represents a 3GPP-based communication system, such as a system of or beyond 5G.

According to an example aspect of the present disclosure, there is provided a method of (or, stated in other words, operable or for use in/by) a communication control node or element in a communication system, which is configured for beam-based operation on an unlicensed spectrum, comprising providing a pathloss measurement configuration, including a reference signal for pathloss measurement, for a communication control node or element.

According to an example aspect of the present disclosure, there is provided an apparatus of (or, stated in other words, operable or for use in/by) a communication control node or element in a communication system, which is configured for beam-based operation on an unlicensed spectrum, comprising at least one processor and at least one memory including computer program code, wherein the processor, with the at least one memory and the computer program code, is configured to cause the apparatus to perform: providing a pathloss measurement configuration, including a reference signal for pathloss measurement, for a communication control node or element.

According to an example aspect of the present disclosure, there is provided an apparatus of (or, stated in other words, operable or for use in/by) a communication control node or element in a communication system, which is configured for beam-based operation on an unlicensed spectrum, comprising: means or circuitry for providing a pathloss measurement configuration, including a reference signal for pathloss measurement, for a communication control node or element.

According to various developments/modifications, any one of the aforementioned method-related and/or apparatus-related example aspects of the present disclosure may include one or more of the following features:
the method, functionality or operability further comprises providing, for the communication control node or element, a channel occupancy time configuration of the communication control node or element, relating to one or more reference signals,
the channel occupancy time configuration comprises: a quasi-co-location assumption of a channel occupancy time of the communication control node or element, and an indication of one or more additional reference signals which are spatially correlated with at least one reference signal providing the quasi-co-location assumption,
the indicated one or more additional reference signals comprise one or more channel state information reference signals and/or comprise or are contained in one or more blocks of a synchronization signal and/or a physical broadcast channel,
the configured reference signal is a channel state information reference signal,
the communication control node or element comprises or represents at least part of a base station entity or an integrated access and backhaul node or element or a central and/or distributed unit entity,
the communication system comprises or represents a 3GPP-based communication system, such as a system of or beyond 5G.

According to an example aspect of the present disclosure, there is provided a computer program product comprising (computer-executable) computer program code which, when the program code is executed (or run) on a computer or the program is run on a computer (e.g. a computer of an apparatus according to any one of the aforementioned apparatus-related example aspects of the present disclosure), is configured to cause the computer to carry out the method according to any one of the aforementioned method-related example aspects of the present disclosure.

The computer program product may comprise or may be embodied as a (tangible/non-transitory) computer-readable (storage) medium or the like, on which the computer-executable computer program code is stored, and/or the program is directly loadable into an internal memory of the computer or a processor thereof.

Further developments and/or modifications of the aforementioned exemplary aspects of the present disclosure are set out in the following.

By way of exemplifying embodiments of the present disclosure, pathloss measurement on an unlicensed spectrum, i.e. arrangement of an appropriate pathloss reference signal for operation on an unlicensed spectrum, can be enabled/realized.

### BRIEF DESCRIPTION OF THE DRAWINGS

In the following, the present disclosure will be described in greater detail by way of non-limiting examples with reference to the accompanying drawings, in which

FIG. 1 shows a flowchart illustrating an example of a method or process according to at least one exemplifying embodiment,

FIG. 2 shows a flowchart illustrating an example of a method or process according to at least one exemplifying embodiment,

FIG. 3 shows a flowchart illustrating an example of a method or process according to at least one exemplifying embodiment,

FIG. 4 shows a schematic diagram illustrating an example of a QCL chain (in a chain of TCI states) applicable to at least one exemplifying embodiment,

FIG. 5 shows a flowchart illustrating an example of a method or process according to at least one exemplifying embodiment,

FIG. 6 shows a flowchart illustrating an example of a method or process according to at least one exemplifying embodiment,

FIG. 7 shows a schematic block diagram illustrating an example of a structure of apparatuses according to at least one exemplifying embodiment, and

FIG. 8 shows a schematic block diagram illustrating an example of a structure of apparatuses according to at least one exemplifying embodiment.

### DETAILED DESCRIPTION

The present disclosure is described herein with reference to particular non-limiting examples and to what are presently considered to be conceivable (examples of) embodiments. A person skilled in the art will appreciate that the present disclosure is by no means limited to these examples and embodiments, and may be more broadly applied.

It is to be noted that the following description mainly refers to specifications being used as non-limiting examples for certain exemplifying network configurations and system deployments. Namely, the following description mainly refers to 3GPP standards, specially referring to 5G/NR/NR-U standardization, being used as non-limiting examples. As such, the description of exemplifying embodiments given herein specifically refers to terminology which is directly related thereto. Such terminology is only used in the context of the presented non-limiting examples and embodiments, and does naturally not limit the present disclosure in any way. Rather, any other system configuration or deployment may equally be utilized as long as complying with what is described herein and/or exemplifying embodiments described herein are applicable to it.

For examples, the present disclosure is equally applicable in any (mobile/wireless) communication system, which is configured for beam-based operation on an unlicensed spectrum (i.e. frequency range or band), i.e. any beam-based (mobile/wireless) communication system operating on an unlicensed spectrum (i.e. frequency range or band), such as 5G/NR/NR-U systems and next generation systems beyond 5G (i.e. 6G, 7G, . . . ), including a relay/relaying scenario, environment or deployment, such as an IAB scenario, environment or deployment.

Hereinafter, various exemplifying embodiments and implementations of the present disclosure and its aspects are described using several variants and/or alternatives. It is generally to be noted that, according to certain needs and constraints, all of the described variants and/or alternatives may be provided alone or in any conceivable combination (also including combinations of individual features of the various variants and/or alternatives). In this description, the words “comprising” and “including” should be understood as not limiting the described exemplifying embodiments and implementations to consist of only those features that have been mentioned, and such exemplifying embodiments and implementations may also contain features, structures, units, modules etc. that have not been specifically mentioned.

In the drawings, it is to be noted that lines/arrows interconnecting individual blocks or entities are generally meant to illustrate an operational coupling there-between, which may be a physical and/or logical coupling, which on the one hand is implementation-independent (e.g. wired or wireless) and on the other hand may also comprise an arbitrary number of intermediary functional blocks or entities not shown. In flowcharts or sequence diagrams, the illustrated order of operations or actions is generally illustrative/exemplifying, and any other order of respective operations or actions is equally conceivable, if feasible.

According to exemplifying embodiments of the present disclosure, in general terms, there are provided measures/mechanisms (including methods, apparatuses (i.e. devices, entities, elements and/or functions) and computer program products) for enabling/realizing pathloss measurement on an unlicensed spectrum (i.e. frequency range or band), i.e. arrangement of an appropriate pathloss reference signal for operation on an unlicensed spectrum (i.e. frequency range or band).

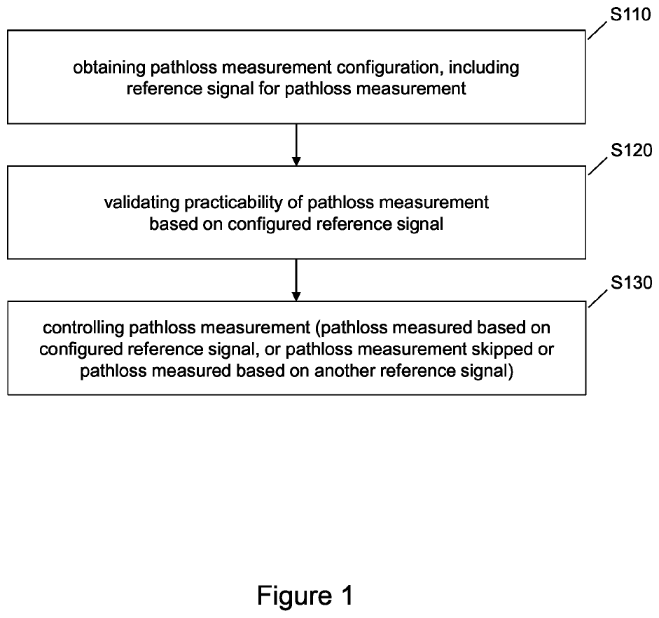

FIG. 1 shows a flowchart illustrating an example of a method or process according to at least one exemplifying embodiment. The method or process of FIG. 1 is a method or process of (or, stated in other words, operable or for use in/by) of a communication node or element in a communication system, such as a user equipment (UE) entity or a mobile termination (MT) part entity, e.g. MT of an IAB node.

As shown in FIG. 1, the method or process comprises an operation (S110) of obtaining a pathloss measurement configuration, including a reference signal for pathloss measurement, an operation (S120) of validating practicability of pathloss measurement based on the configured reference signal, and an operation (S130) of controlling pathloss measurement. In controlling pathloss measurement, which is based/depending on the result of the practicability validation, pathloss is measured based on (e.g. on or using) the configured reference signal in a case where the configured reference signal is practicable, or pathloss measurement is skipped or pathloss is measured based on (e.g. on or using) another reference signal being on the same quasi-co-location chain (QCL) as the configured reference signal in a case where the configured reference signal is not practicable.

According to at least one exemplifying embodiment, the pathloss measurement may be performed in/during or for a (detected) channel occupancy time (COT) of a serving communication control node or element, such as a gNB, of/for the executing communication control node or element, particularly in/during or for a (channel) transmission on an unlicensed spectrum. In a 5G/NR/NR-U system, such unlicensed spectrum may be the 60 GHz band or the frequencies between 52.6 GHz and 71 GHz.

According to at least one exemplifying embodiment, the practicability validation may comprise checking presence of the configured reference signal, wherein the configured reference signal is practicable when being present, and/or checking validity of the configured reference signal, wherein the configured reference signal is practicable when being valid. Checking presence and/or validity may be based on monitoring of a channel, especially a DL channel, such as a physical downlink control channel (PDCCH).

According to at least one exemplifying embodiment, the configured reference signal may be a channel state information reference signal (CSI-RS), and/or the another reference signal may be or contained in a block of a synchronization signal and/or a physical broadcast channel (SS/PBCH block or SSB).

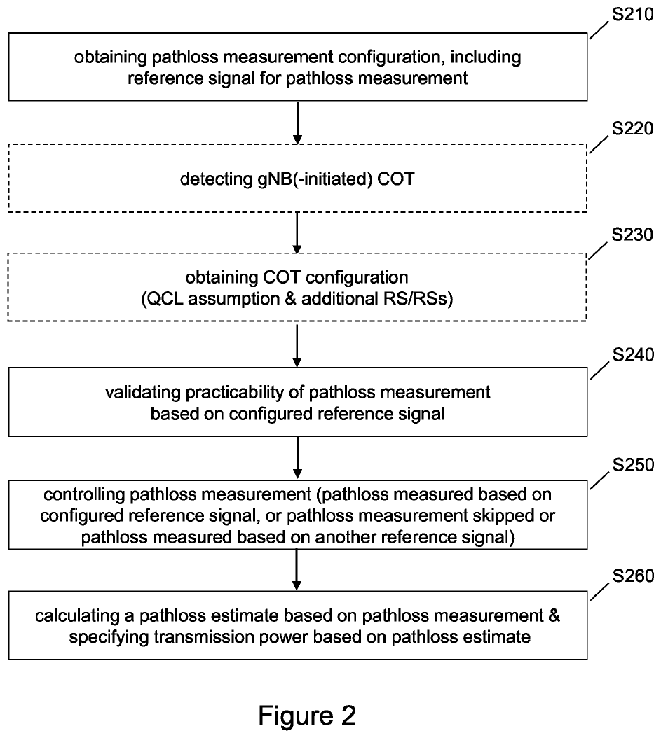

FIG. 2 shows a flowchart illustrating an example of a method or process according to at least one exemplifying embodiment. The method or process of FIG. 2 is a method or process of (or, stated in other words, operable or for use in/by) of a communication node or element in a communication system, such as a user equipment (UE) entity or a mobile termination (MT) part entity, e.g. MT of an IAB node.

As shown in FIG. 2, the method or process comprises, in addition to the operations like in FIG. 1 (which are denoted as operations S210, S240 and S250 here), an operation (S260) of calculating a pathloss estimate between the communication node or element and a serving communication control node or element (e.g. the serving gNB) based on the pathloss measurement (in a case where the pathloss measurement was performed in the pathloss controlling operation (S250)), and specifying a transmission power for an uplink signal and/or channel based on the calculated pathloss estimate. It is to be noted that such operation may be regarded as a single/common operation or two distinct operations.

For example, the pathloss estimate may be calculated as follows:

$${PL}_{b , f , c} ( {q}_{d} ) = referenceSignalPower - higher layer filtered RSRP$$

where
PL_{b,f,c}(q_{d}) is a downlink pathloss estimate in dB calculated by the UE using reference signal (RS) index r for the active DL BWP b of carrier f of serving cell c,
referenceSignalPower is provided by a higher layer (e.g. L3),
RSRP is defined for the serving cell, and
the higher layer (e.g. L3) filter configuration may be provided by QuantityConfig for the serving cell

If the UE is not configured with/for periodic CSI-RS reception, referenceSignalPower is provided by ss-PBCH-BlockPower. If the UE is configured with/for periodic CSI-RS reception, referenceSignalPower is provided either by ss-PBCH-BlockPower or by powerControlOffsetSS providing an offset of the CSI-RS transmission power relative to the SS/PBCH block (SSB) transmission power. If powerControlOffsetSS is not provided to the UE, the UE assumes an offset of 0 dB.

The pathloss, i.e. the calculated pathloss estimate, may be used to determine UE transmit power for different UL channels. For example, for PUSCH, transmit power (in dBm) may be defined as follows:

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{n} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \}$$

Namely, the PUSCH transmission power P_{PUSCH,b,f,c}(i,j,q_{d},l) in PUSCH transmission occasion i is determined by the UE, if the UE transmits a PUSCH on active UL BWP b of carrier f of serving cell c using a parameter set configuration with index j and PUSCH power control adjustment state with index l.

According to at least one exemplifying embodiment, as shown in FIG. 2, the method or process may also comprise an operation (S220) of detecting a channel occupancy time (COT), i.e. channel occupation for transmission, of a serving communication control node or element (e.g. the serving gNB). If so, the operations of validating and controlling are performed in or for the detected channel occupancy time (COT), i.e. channel occupation for transmission, of the serving communication control node or element (e.g. the serving gNB). The operation of calculating/specifying may be based on multiple measurements which may be performed on different COTs, and/or a PUSCH transmission may be but is not necessarily in or for the detected (gNB-initiated) COT.

According to at least one exemplifying embodiment, as shown in FIG. 2, the method or process may also comprise an operation (S230) of obtaining a channel occupancy time (COT) configuration of a serving communication control node or element (e.g. the serving gNB), relating to one or more reference signals. For example, the channel occupancy time (COT) configuration may comprises a quasi-co-location (QCL) assumption of a channel occupancy time (COT) of the serving communication control node or element (e.g. the serving gNB), and/or an indication of one or more additional reference signals which are spatially correlated with at least one reference signal providing the quasi-co-location (QCL) assumption. If so, the validating may comprise checking correspondence of the configured reference signal, i.e. the reference signal for pathloss measurement (as included in the previously obtained pathloss measurement configuration) with the one or more reference signals. As the result of the practicability validation, the configured reference signal may be practicable when corresponding to at least one of the one or more reference signals.

According to at least one exemplifying embodiment, the practicability validation based on the COT configuration may be performed/realized in addition or as alternative to the practicability validation based on the presence/validity check as described in connection with FIG. 1.

For any operations correspond to respective operations in FIG. 1, reference is made to the foregoing description of FIG. 1.

It is to be noted that that additionally illustrated operations S220, S230 and S260 are basically independent from each other. Accordingly, any combination of one or more of these additionally illustrated operations may be involved in a method or process according to at least one exemplifying embodiment (although all of them are illustrated for the sake of convenience). Also, the sequence between certain ones of the illustrated operations may be different than shown, e.g. operations S210, S220 and S230 may be performed in another order and/or in an at least partially parallel or overlapping manner.

Referring to the methods or processes of FIGS. 1 and 2, any obtaining operation may be performed/realized by a corresponding receiving operation. Namely, the pathloss measurement configuration may be received (as (part of) a message, signal, or the like) in step S110 or S210, and/or the COT configuration may be received (as (part of) a message, signal, or the like) in step S230. Such configuration/s may be received from a serving communication control node or element (e.g. the serving gNB).

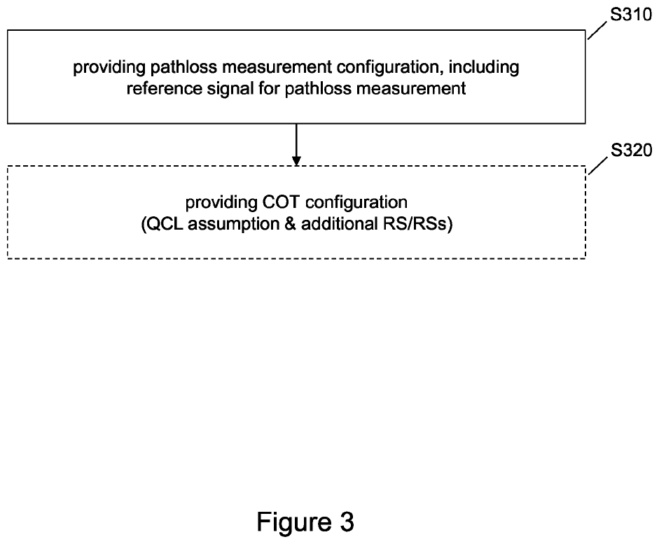

FIG. 3 shows a flowchart illustrating an example of a method or process according to at least one exemplifying embodiment. The method or process of FIG. 3 is a method or process of (or, stated in other words, operable or for use in/by) of a communication control node or element in a communication system, such as a base station entity, e.g. a gNB, or a central and/or distributed unit entity, e.g. CU/DU of an IAB donor.

As shown in FIG. 3, the method or process comprises an operation (S310) of providing a pathloss measurement configuration, including a reference signal for pathloss measurement, for a communication control node or element (e.g. a served UE).

According to at least one exemplifying embodiment, the configured reference signal may be a channel state information reference signal (CSI-RS).

According to at least one exemplifying embodiment, as shown in FIG. 3, the method or process may also comprise and operation (S320) of providing, for the communication control node or element (e.g. the served UE), a channel occupancy time configuration of a serving communication control node or element, relating to one or more reference signals. For example, the channel occupancy time (COT) configuration may comprises a quasi-co-location (QCL) assumption of a channel occupancy time (COT) of the serving communication control node or element, and/or an indication of one or more additional reference signals which are spatially correlated with at least one reference signal providing the quasi-co-location (QCL) assumption. For example, the indicated one or more additional reference signals may comprise one or more channel state information reference signals (CSI-RSs) and/or one or more blocks of a synchronization signal and/or a physical broadcast channel (SS/PBCH blocks or SSBs).

Referring to the method or process of FIG. 3, any providing operation may be performed/realized by a corresponding transmitting, sending or issuing operation. Namely, the pathloss measurement configuration may be transmitted, sent or issued (as (part of) a message, signal, or the like) in step S310, and/or the COT configuration may be transmitted, sent or issued (as (part of) a message, signal, or the like) in step S320. Such configuration/s may be transmitted, sent or issued to the (served) communication node or element (e.g. the served UE).

In the foregoing description, reference is made to quasi-co-location (QCL), particularly a QCL chain and a QCL assumption. In the following, this concept is explained in further detail.

Basically, the concept of quasi-co-location (QCL) is applied for beam management in 5G/NR/NR-U systems. Beam management comprises a set of procedures and functionalities that enable, maintain and refine transmit and receive beam alignment between a transmitter and one or more receivers. A beam pair link established between a transmitter (e.g. gNB) and a receiver (e.g. UE) comprises a transmit beam and receive beam pair.

The beam pair link between gNB and UE may be the same or different in downlink and uplink.

The quasi-co-location (QCL) of two antenna ports means that the channel conditions for the symbols, such as reference signals, transmitted from those antenna ports are similar. While in practice the gNB can only guarantee that the properties of two reference signals are similar if the two reference signals are transmitted from the same transmission and reception point (TRP), the QCL defines the relation between two reference signals at the UE receiver.

A QCL indication/relationship may be indicated by a TCI state, and may be of different predetermined/specified types depending on the set of properties for the channel conditions, namely QCL-TypeA, QCL-TypeB, QCL-TypeC, QCL-TypeD. Herein, QCL-TypeD is specifically assumed (as an example), where a spatial RX parameter is employed to define the channel conditions and is used to support beamforming. The spatial RX parameter may represent properties associated with an angle-of-arrival at the UE, or the like.

In downlink, the gNB provides the UE with a reference signal (RS) and a related quasi-co-location (QCL) indication/relationship, e.g. a QCL-TypeD RS, based on which the UE can set its (DL) receive beam, and a spatial relation information for uplink, based on which the UE can further set its (UL) transmit beam. In other words, in downlink, the UE may use the same RX beam to receive the target DL signal as it used to receive the provided reference signal (source signal).

A QCL chain is defined by a chain of TCI states, where the first node in the chain comprises an SSB as QCL-TypeD RS, and the QCL-TypeD RS of the next TCI state is having the first TCI state as the QCL source, and so on.

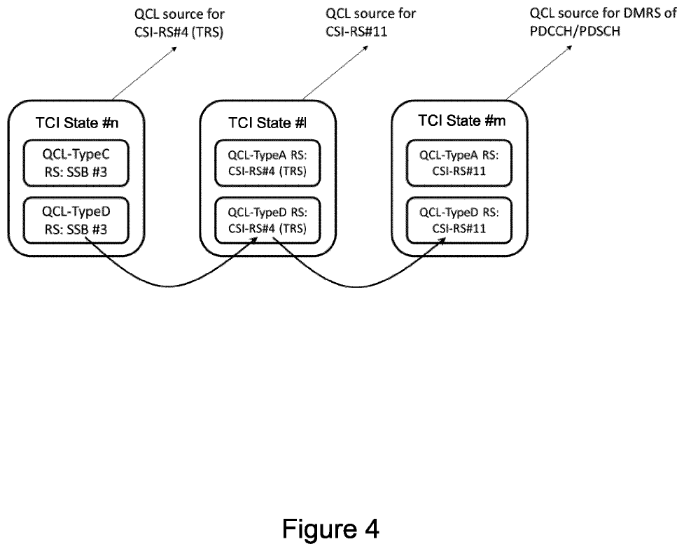

FIG. 4 shows a schematic diagram illustrating an example of a QCL chain (in a chain of TCI states) applicable to at least one exemplifying embodiment.

Generally, as is evident from FIG. 4, the TCI states provide QCL relations between one of more DL RSs and DMRS of PDCCH, DMRS of PDSCH or CSI-RS of a CSI-RS resource. In the illustrated example, the resulting QCL assumption resides in that SSB #3 is quasi-co-located with CSI-RS #4, CSI-RS #4 is quasi-co-located with CSI-RS #1, and CSI-RS #1 is quasi-co-located with DMRS of PDCCH/PDSCH. Accordingly, it can be said that the resulting QCL assumption resides in that SSB #3, CSI-RS #4 and CSI-RS #1 are quasi-co-located with DMRS of PDCCH/PDSCH. Accordingly, the QCL chain comprise or indicates a QCL assumption (of a related COT).

As is shown in FIG. 4, the QCL-TypeD RS can be e.g. SSB or CSI-RS. In beam indication for the target signal to be received (e.g. DMRS of PDSCH, DMRS of PDCCH, CSI-RS), the UE is provided with a TCI state (container) that comprises an indication of the QCL-TypeD RS, and the UE applies the same RX beam to receive the target signal (e.g. PDSCH, PDCCH, CSI-RS) as it used to receive the given QCL-TypeD RS (e.g. the corresponding SSB or CSI-RS resource) in the TCI state. The UE can be configured with up to 64 or 128 (if UE capability allows) TCI states.

For uplink, the gNB provides the UE with a spatial source RS, which can be SSB, CSI-RS or SRS. In case of SSB or CSI-RS, the UE uses the RX beam used to receive the given SSB or CSI-RS resource as spatial relation for the TX beam to transmit the target signal (e.g. PUSCH, PUCCH, SRS). In case of SRS, the UE uses as TX beam to transmit the target signal the same TX beam as is used to transmit the given SRS resource.

In the following, some examples of conceivable implementations/realizations of the aforementioned procedure, operations and concepts are explained in further detail.

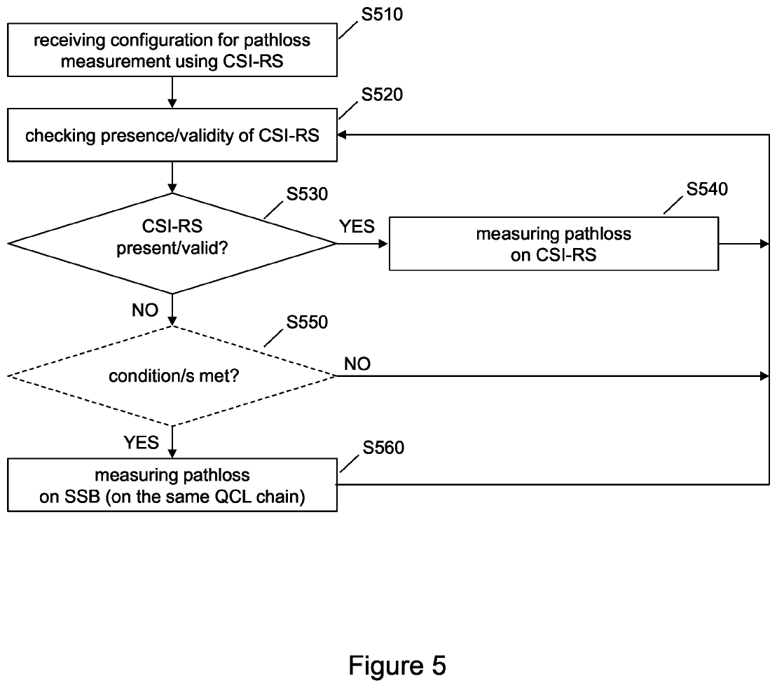

FIG. 5 shows a flowchart illustrating an example of a method or process according to at least one exemplifying embodiment. The method or process of FIG. 5 is a method or process of (or, stated in other words, operable or for use in/by) of a communication node or element in a communication system, such as a user equipment (UE) entity or a mobile termination (MT) part entity, e.g. a MT of an IAB node.

In S510, the UE receives a PL measurement configuration, i.e. a configuration for PL measurement, using CSI-RS. Namely, CSI-RS is configured as the PL RS. This configuration may be received from the serving gNB, either prior to, upon initiation of or during a (gNB-initiated) COT. Assuming that the UE is in RRC connected stated, this configuration may be provided from the serving gNB to the UE by/via RRC signaling. Accordingly, the UE is configured to perform channel measurement for PL calculation/estimation on the configured CSI-RS resource. Such configuration may be provided/applicable for any UL signal and/or channel.

Although not explicitly illustrated in FIG. 5, the UE, at some appropriate time and by some appropriate measure, (checks for and) detects (presence) of a (gNB-initiated) COT. This may be performed/realized before or during operation S520.

In S520, the UE validates the practicability of PL measurement based on (e.g. on or using) the configured PL RS by checking its presence and/or validity, i.e. presence and/or validity of the CSI-RS resource.

The UE may consider that the CSI-RS (resource) is present when an indication is obtained (received), which indicates that the CSI-RS is (temporarily) part of short control signaling (SCS), i.e. contention/LBT exempt transmission. Such indication may be based on or included in a MAC CE or on (detection of) a PDCCH (containing DCI common for a group of UEs, such as DCI 2.0), or may be part of CSI-RS configuration (namely, the pathloss measurement configuration of CSI-RS as PL RS), e.g. information that a configured sub-set (periodicity) of CSI-RS occurrences would be part of SCS. When referring to temporal involvement in SCS, such indication may be valid for a predetermined period (time window).

Additionally or alternatively, the UE may consider that the CSI-RS (resource) is present when an indication is obtained (received), which indicates that the CSI-RS is within a served beam, namely the beam/s that is/are served in/during the (gNB-initiated) COT. Such indication may represent or comprise an indication that at least one of RS(s) providing the QCL assumption for the COT is earlier on the same QCL chain as the CSI-RS or has the same QCL chain as the CSI-RS. Any such indication may, for example, be or be based on (detection of) a PDCCH (containing DCI common for a group of UEs, such as DCI 2.0) with DMRS on the same QCL chain as the configured reference signal, and/or DCI content on PDCCH (e.g. COT duration). Accordingly, the checking operation in S520 may comprise monitoring a PDCCH, e.g. in terms of the aforementioned indications/features. It is to be noted that obtaining (receiving) such indication may also indicate that the gNB has initiated a COT such that it may also be used for detecting (presence) of a (gNB-initiated) COT.

The UE may consider whether the CSI-RS (resource) is valid or invalid based on a resource type or resource type configuration. More specifically, the UE may consider that the CSI-RS (resource) is invalid if an indication is obtained (received), which indicates that the CSI-RS resource is not a DL (or DL/flexible) resource. Hence, the CSI-RS may be considered valid when the CSI-RS has or relates to a DL or flexible resource. A resource type configuration (Downlink, Uplink, Flexible) may be received via at least one of cell-specific RRC configuration, dedicated RRC configuration and PDCCH. In the absence of a resource type configuration, resources may be considered as flexible, which indicates that they are available for both DL reception and UL transmission.

If the checking operation, i.e. the practicability check, yields that PL measurement based on the CSI-RS is practicable as the CSI-RS is present and valid (i.e. YES in S530), the PL measurement, i.e. the channel measurement for PL calculation/estimation, based on (e.g. on or using) the CSI-RS is performed in S540. Thereafter, the procedure returns to S520.

If the checking operation, i.e. the practicability check, yields that PL measurement based on the CSI-RS is not practicable as the CSI-RS is not present and/or valid (i.e. NO in S530), the PL measurement, i.e. the channel measurement for PL calculation/estimation, is performed based on (e.g. on or using) another RS as the PL RS in S560. The another RS is a SSB which is on the same QCL chain as the (previously/originally configured) CSI-RS. Accordingly, S560 comprises identification or determination of an applicable SSB by the UE, or is based on a preceding identification or determination of an applicable SSB by the UE. Thereafter, the procedure returns to S520.

In S560, the SSB may be seen as a secondary or fallback PL RS for PL measurement when the previously/originally configured PL RS is not practicable for PL measurement.

Yet, as indicated by dashed lines in FIG. 5, there may be an additional operation of checking one or more conditions in S550. If so, the procedure may proceed to S560 so as to perform PL measurement based on SSB when the at least one condition is met (i.e. YES in S550), and the procedure may directly return to S520, thus skipping (or ignoring/discarding) any PL measurement, when the at least one condition is not met (i.e. NO in S550).

As one example, a condition (to be checked in S550) may be that the SSB occurs within a predetermined period (time window) relative to an occasion of the previously/originally configured PL RS, i.e. the CSI-RS. The period (time window) may depend e.g. on CSI-RS periodicity and/or SSB periodicity and/or SMTC configuration, or the like. That is, the SSB is or can only be used in/for PL measurement when occurring within this period (time window).

As another example, a condition (to be checked in S550) may be that there is no PL measurement based on the previously/originally configured PL RS, i.e. the CSI-RS, for a predetermined period (time window). That is, the SSB is or can only be used in/for PL measurement when there is no PL measurement based on the CSI-RS for this period (time window).

In S540, PL calculation/estimation based on the CSI-RS may be performed, as is described above. Namely, the equation

$${PL}_{b , f , c} ( {q}_{d} ) = referenceSignalPower - higher layer filtered RSRP$$

can be employed with the provided parameters/configurations.

In S560, PL calculation/estimation based on the CSI-RS may be performed on the basis of the above equation, yet with adapted or modified parameters/configurations.

As one example, a different higher layer filter configuration may be applied. Namely, the RSRP (derived from SSB measurement) may be subjected to filtering with a higher layer (e.g. L3) filter configuration, which is different from the higher layer (e.g. L3) filter configuration in the obtained pathloss measurement configuration, i.e. that provided for the CSI-RS. The applied higher layer filter configuration may depend on the applicability of short control signaling (SCS), i.e. contention/LBT exempt transmission, e.g. whether it is applied always or only on certain time occasions for the given SSB (index). For example, the UE may use only SSB when the UE can determine that SSB has been actually transmitted. For determination, the UE may use knowledge that SSBs can be always transmitted due to a SCS rule in/for the cell, for example.

As another example, a value of powerControlOffsetSS (providing an offset of the CSI-RS transmission power relative to the SSB (SSH/PBCH) transmission power) may be used for determining a reference signal power (referenceSignalPower) to be used in pathloss estimate calculation. Thereby, a compensation for the use of the offset on the referenceSignalPower calculation may be applied.

In view of the procedure of FIG. 5, according to at least one embodiment, pathloss measurement can be performed based on (e.g. on or using) the configured PL RS, as this is deemed to be practicable, when the configured PL RS is spatially within the beam/s that is/are served in/during the (gNB-initiated) COT, such as the beam providing the PL RS.

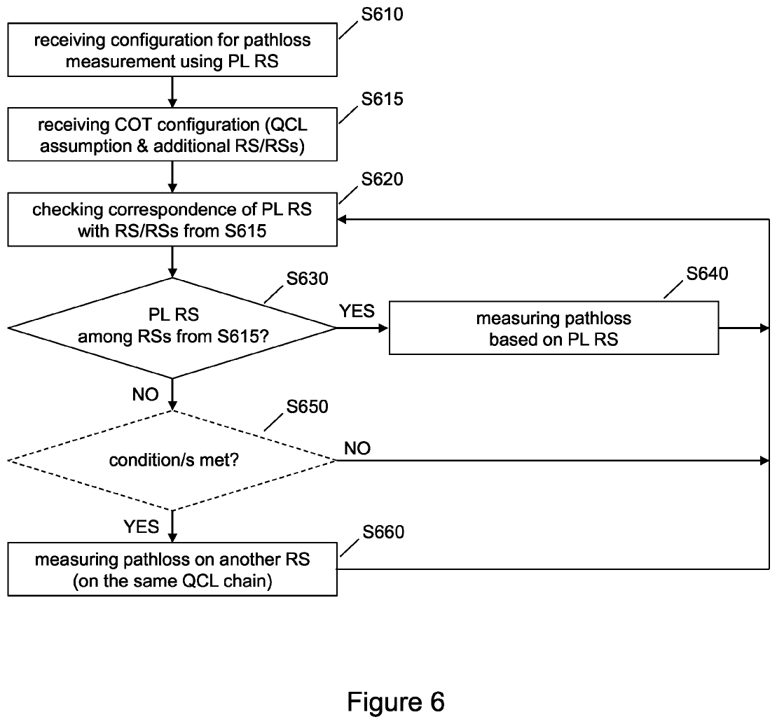

FIG. 6 shows a flowchart illustrating an example of a method or process according to at least one exemplifying embodiment. The method or process of FIG. 6 is a method or process of (or, stated in other words, operable or for use in/by) of a communication node or element in a communication system, such as a user equipment (UE) entity or a mobile termination (MT) part entity, e.g. a MT of an IAB node.

In S610, the UE receives a PL measurement configuration, i.e. a configuration for PL measurement, using some PL RS such as e.g. CSI-RS. This configuration may be received from the serving gNB, either prior to, upon initiation of or during a (gNB-initiated) COT. Assuming that the UE is in RRC connected stated, this configuration may be provided from the serving gNB to the UE by/via RRC signaling. Accordingly, the UE is configured to perform channel measurement for PL calculation/estimation on the configured PL RS resource. Such configuration may be provided/applicable for any UL signal and/or channel.

Although not explicitly illustrated in FIG. 6, the UE, at some appropriate time and by some appropriate measure, (checks for and) detects (presence) of a (gNB-initiated) COT. This may be performed/realized before or during operation S615.

In S615, the UE receives a COT configuration of the serving gNB, relating to one or more reference signals. It is to be noted that receiving (obtaining) such COT configuration may also indicate that the gNB has initiated a COT such that it may also be used for detecting (presence) of a (gNB-initiated) COT.

For example, as the COT configuration, the gNB provides, e.g. when initiating the (gNB-initiated) COT, the QCL assumption of the COT, e.g. SSB or CSI-RS, and also additionally SSB indices and/or CSI-RS indices that are spatially correlated, e.g. overlapped or partially overlapped, with the SSB or CSI-RS providing the QCL assumption of the COT or, stated in other words, the RS(s) used during/in the (gNB-initiated) COT. The QCL assumption of the COT represents/indicates the RS, i.e. SSB and/or CSI-RS indicating the (transmit) beam/s that is/are served in/during the (gNB-initiated) COT, and the list of additional RS indices represents/indicates RS/RSs, i.e. SSB/s and/or CSI-RS/S with spatial correlation to the (transmit) beam/s that is/are served in/during the (gNB-initiated) COT. It is to be noted that these parts/features of the COT configuration may be provided commonly or at once, e.g. by a single/common message or the like, or may be provided separately, e.g. by distinct messages, at different times, or the like.

In S620, the UE validates the practicability of PL measurement based on (e.g. on or using) the configured PL RS by checking correspondence of the configured PL RS with the one or more reference signals, to which the COT configuration (as received in S615) relates. In the aforementioned example, the one or more reference signals (relating to the COT configuration) comprise the SSB or CSI-RS providing the QCL assumption and the additional SSB indices and/or CSI-RS indices that are spatially correlated, e.g. overlapped or partially overlapped, with the SSB or CSI-RS providing the QCL assumption of the COT or, stated in other words, the RS(s) used during/in the (gNB-initiated) COT.

In other words, the UE can determine if its configured PL RS is among the thus indicated RSs, i.e. the RS providing the QCL assumption and the additionally indicated RSs. If so, the UE can perform PL measurement from the QCL-assumption-providing RS of the COT and/or any of the RSs in the list of additional RSs and/or any (DL) RS sharing the same QCL assumption in the COT. In other words, the configured PL RS may be considered as an applicable RS in S660.

It is to be noted that the gNB is able and configured to determine similarity between beams, such as spatial correlation between certain beams and the SSB or CSI-RS providing the QCL assumption of the COT, and is thus able and configured to identify similar, e.g. spatially correlated, beams and to generate the list of additional RSs accordingly.

It is to be noted that the UE is able and configure to determine/identify any (DL) RS sharing the same QCL assumption in the COT. If the UE finds that one of its RSs is or shared either the QCL assumption of the COT or is among the list of additional RSs that share the similar characteristics as the QCL assumption of the COT, the UE is able and configured to perform PL measurement from or, stated in other words, based on the QCL assumption RS of the COT.

If the checking operation, i.e. the practicability check, yields that PL measurement based on the configured PL RS is practicable as the PL RS is among the applicable RSs per gNB's COT configuration (i.e. YES in S630), the PL measurement, i.e. the channel measurement for PL calculation/estimation, based on (e.g. on or using) the configured PL RS is performed in S640. Thereafter, the procedure returns to S620.

Stated on other words, if the UE's configured PL RS is the same as the RS providing the QCL assumption of the COT or any of the RSs in the list of additional RSs, the UE performs PL measurement from the RS providing the QCL assumption of the COT and/or any of the RSs in the list of additional RSs and/or any DL RS sharing the same QCL assumption in the COT.

If the checking operation, i.e. the practicability check, yields that PL measurement based on the configured PL RS is not practicable as PL RS is not among the applicable RSs per gNB's COT configuration (i.e. NO in S630), the PL measurement, i.e. the channel measurement for PL calculation/estimation, is performed based on (e.g. on or using) another RS as the configured PL RS in S660. Accordingly, S660 comprises identification or determination of an applicable RS by the UE, or is based on a preceding identification or determination of an applicable RS by the UE. The another RS is another RS which is on the same QCL chain as the (previously/originally) configured PL RS. Thereafter, the procedure returns to S620.

In S660, the another RS may be seen as a secondary or fallback PL RS for PL measurement when the previously/originally configured PL RS is not practicable for PL measurement.

As regards S650, i.e. the optional checking of conditions and the thus related specifics and consequences, references is made to the description in connection with S550 of FIG. 5, since these operations of FIGS. 5 and 6 are basically the same or equivalent. The same applies to operations S640 and S660, i.e. the PL measurement based on some PL RS, for which, due to their basic equality or equivalence, reference is to the description of S540 and S560 of FIG. 5, respectively.

In view of the procedure of FIG. 6, according to at least one embodiment, pathloss measurement can be performed based on (e.g. on or using) the configured PL RS, as this is deemed to be practicable, when the configured PL RS is (sufficiently) correlated, e.g. overlapped or partially overlapped, with the beam/s that is/are served in/during the (gNB-initiated) COT, such as the beam providing the PL RS.

By virtue of exemplifying embodiments of the present disclosure, as evident from the above, pathloss measurement on an unlicensed spectrum (i.e. frequency range or band), i.e. arrangement of an appropriate pathloss reference signal for operation on an unlicensed spectrum (i.e. frequency range or band), can be enabled/realized.

According to exemplifying embodiments, issues and/or problems and drawbacks of conventional system may be beneficially addressed. For example, it may be compensated for the confinement of CSI-RS transmissions to gNB COTs, degradation in the accuracy of calculating a pathloss or a pathloss estimate and, hence, transmit power control when the gNB has not initiated a COT containing CSI-RS for some time may be avoided, or the like. In this regard, the performance of transmit power control mechanisms can be improved in that the frequency can be increased, by which an appropriate pathloss measurement (and calculation/estimation) can be performed.

The above-described functionality as well as its related operations, procedures, methods and processes may be implemented by respective functional elements, entities, modules, units, processors, or the like, as described below. These functional elements, entities, modules, units, processors, or the like, i.e. the implementation of one or more exemplifying embodiments, may be realized in a cloud environment.

While in the foregoing exemplifying embodiments of the present disclosure are described mainly with reference to operations, procedures, methods and processes, corresponding exemplifying embodiments of the present disclosure also cover respective apparatuses, entities, modules, units, network nodes and/or systems, including software and/or hardware thereof.

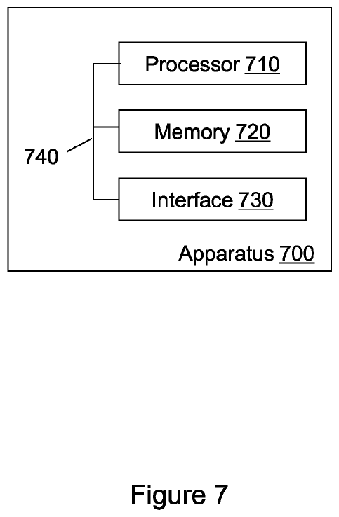

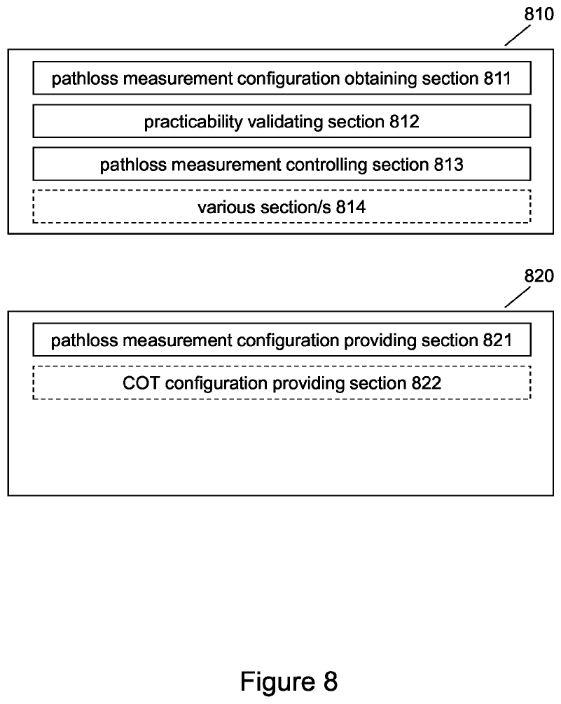

Respective exemplifying embodiments of the present invention are described below referring to FIGS. 7 and 8, while for the sake of brevity reference is made to the detailed description of respective corresponding configurations/setups, schemes, processes, sequences, methods as well as functionalities, principles and operations according to FIGS. 1 to 6.

In FIGS. 7 and 8, the blocks are basically configured to perform respective methods, procedures and/or functions as described above. The entirety of blocks are basically configured to perform the methods, procedures and/or functions as described above, respectively. With respect to FIGS. 7 and 8, it is to be noted that the individual blocks are meant to illustrate respective functional blocks implementing a respective function, process or procedure, respectively. Such functional blocks are implementation-independent, i.e. may be implemented by means of any kind of hardware or software or combination thereof, respectively.

Further, in FIGS. 7 and 8, only those functional blocks are illustrated, which relate to any one of the above-described methods, procedures and/or functions. A skilled person will acknowledge the presence of any other conventional functional blocks required for an operation of respective structural arrangements, such as e.g. a power supply, a central processing unit, respective memories or the like. Among others, one or more memories are provided for storing programs or program instructions for controlling or enabling the individual functional entities or any combination thereof to operate as described herein in relation to exemplifying embodiments.

FIG. 7 shows a schematic diagram illustrating an example of a structure of apparatuses according to at least one exemplifying embodiment. Herein, an apparatus can represent a physical entity or component, i.e. a structural device implementing a specific network element, entity or function or the functionality thereof as such, or a functional or logical entity or component. For example, the thus illustrated apparatus may be realized in or by a server or the like in a cloud environment, i.e. by a cloud-based implementation, by way of software-defined networking (SDN), by way of network function virtualization (NFV), or the like.

As indicated in FIG. 7, according to at least one exemplifying embodiment, an apparatus 700 may comprise or realize at least one processor 710 and at least one memory 720 (and possibly also at least one interface 730), which may be operationally connected or coupled, for example by a bus 740 or the like, respectively.

The processor 710 and/or the interface 730 of the apparatus 700 may also include a modem or the like to facilitate communication over a (hardwire or wireless) link, respectively. The interface 730 of the apparatus 700 may include a suitable transmitter, receiver or transceiver connected or coupled to one or more antennas, antenna units, such as antenna arrays or communication facilities or means for (hardwire or wireless) communications with the linked, coupled or connected device(s), respectively. The interface 730 of the apparatus 700 is generally configured to communicate with at least one other apparatus, device, node or entity (in particular, the interface thereof).

The memory 720 of the apparatus 700 may represent a (non-transitory/tangible) storage medium (e.g. RAM, ROM, EPROM, EEPROM, etc.) and store respective software, programs, program products, macros or applets, etc. or parts of them, which may be assumed to comprise program instructions or computer program code that, when executed by the respective processor, enables the respective electronic device or apparatus to operate in accordance with the exemplifying embodiments of the present invention. Further, the memory 720 of the apparatus 700 may (comprise a database to) store any data, information, or the like, which is used in the operation of the apparatus.

In general terms, respective apparatuses (and/or parts thereof) may represent means for performing respective operations and/or exhibiting respective functionalities, and/or the respective devices (and/or parts thereof) may have functions for performing respective operations and/or exhibiting respective functionalities.

In view of the above, the thus illustrated apparatus 700 is suitable for use in practicing one or more of the exemplifying embodiments, as described herein.

When in the subsequent description it is stated that the processor (or some other means) is configured to perform some function, this is to be construed to be equivalent to a description stating that a (i.e. at least one) processor or corresponding circuitry, potentially in cooperation with a computer program code stored in the memory of the respective apparatus or otherwise available (it should be appreciated that the memory may also be an external memory or provided/realized by a cloud service or the like), is configured to cause the apparatus to perform at least the thus mentioned function. It should be appreciated that herein processors, or more generally processing portions, should not be only considered to represent physical portions of one or more processors, but may also be considered as a logical division of the referred processing tasks performed by one or more processors.

According to at least one exemplifying embodiment, the thus illustrated apparatus 700 may represent or realize/embody a (part of a) communication node or element in a communication system, such as a user equipment (UE) entity or a mobile termination (MT) part entity, e.g. MT of an IAB node. Hence, the apparatus 700 may be configured to perform a procedure and/or exhibit a functionality and/or implement a mechanism, as described (for a communication node or element, e.g. a UE) in any one of FIGS. 1, 2 and 4 to 6.

Accordingly, the apparatus 700 may be caused or the apparatus 700 or its at least one processor 710 (possibly together with computer program code stored in its at least one memory 720), in its most basic form, is configured to obtain a pathloss measurement configuration, including a reference signal for pathloss measurement, validate practicability of pathloss measurement based on the configured reference signal, and control pathloss measurement, wherein pathloss is measured based on the configured reference signal in a case where the configured reference signal is practicable, or pathloss measurement is skipped or pathloss is measured based on another reference signal being on the same quasi-co-location chain as the configured reference signal in a case where the configured reference signal is not practicable.

According to at least one exemplifying embodiment, the thus illustrated apparatus 700 may represent or realize/embody a (part of a) a communication control node or element in a communication system, such as a base station entity, e.g. a gNB, or a central and/or distributed unit entity, e.g. CU/DU of an IAB donor. Hence, the apparatus 700 may be configured to perform a procedure and/or exhibit a functionality and/or implement a mechanism, as described (for a communication control node or element, e.g. a gNB) in any one of FIGS. 3 to 6.

Accordingly, the apparatus 700 may be caused or the apparatus 700 or its at least one processor 710 (possibly together with computer program code stored in its at least one memory 720), in its most basic form, is configured to provide a pathloss measurement configuration, including a reference signal for pathloss measurement, for a communication control node or element.

For further details regarding the operability/functionality of the apparatus (i.e. the processor 710 (possibly together with computer program code stored in its at least one memory 720)) according to exemplifying embodiments, reference is made to the above description in connection with any one of FIGS. 1 to 6, respectively.

As mentioned above, an apparatus according to at least one exemplifying embodiment may be structured by comprising respective units or means for performing corresponding operations, procedures and/or functions. For example, such units or means may be implemented/realized on the basis of an apparatus structure, as exemplified in FIG. 7, i.e. by one or more processors 710, one or more memories 720, one or more interfaces 730, or any combination thereof.

FIG. 8 shows a schematic diagram illustrating an example of a structure of apparatuses according to at least one exemplifying embodiment.

As shown in FIG. 8, an apparatus 810 according to at least one exemplifying embodiment may represent or realize/embody a (part of a) communication node or element in a communication system, such as a user equipment (UE) entity or a mobile termination (MT) part entity, e.g. MT of an IAB node. Hence, the apparatus 810 may be configured to perform a procedure and/or exhibit a functionality and/or implement a mechanism, as described (for a communication node or element, e.g. a UE) in any one of FIGS. 1, 2 and 4 to 6.

Such apparatus may comprise (at least) a unit or means for an obtaining unit/means/circuitry denoted by pathloss measurement configuration obtaining section 811, which represents any implementation for (or configured to) obtaining (obtain) a pathloss measurement configuration, including a reference signal for pathloss measurement, a validating unit/means/circuitry denoted by practicability validating section 812, which represents any implementation for (or configured to) validating (validate) practicability of pathloss measurement based on the configured reference signal, and a controlling unit/means/circuitry denoted by pathloss measurement controlling section 813, which represents any implementation for (or configured to) controlling (control) pathloss measurement, wherein pathloss is measured based on the configured reference signal in a case where the configured reference signal is practicable, or pathloss measurement is skipped or pathloss is measured based on another reference signal being on the same quasi-co-location chain as the configured reference signal in a case where the configured reference signal is not practicable.

Further, such apparatus may also comprise one or more sections 814, which represent any implementation, such as a unit, a means, a circuitry or the like, for (or configured to) realize/implement any one of the additional and/or optional functionalities or operations of the communication node or element, as described above, e.g. (for a communication node or element, e.g. a UE) in any one of FIGS. 1, 2 and 4 to 6.

As shown in FIG. 8, an apparatus 820 according to at least one exemplifying embodiment may represent or realize/embody a (part of a) communication control node or element in a communication system, such as a base station entity, e.g. a gNB, or a central and/or distributed unit entity, e.g. CU/DU of an IAB donor. Hence, the apparatus 820 may be configured to perform a procedure and/or exhibit a functionality and/or implement a mechanism, as described (for a communication control node or element, e.g. a gNB) in any one of FIGS. 3 to 6.

Such apparatus may comprise (at least) a providing unit/means/circuitry denoted by pathloss measurement configuration providing section 821, which represents any implementation for (or configured to) providing (provide) a pathloss measurement configuration, including a reference signal for pathloss measurement, for a communication control node or element.

Further, such apparatus may also comprise one or more sections 822, which represent any implementation, such as a unit, a means, a circuitry or the like, for (or configured to) realize/implement any one of the additional and/or optional functionalities or operations of the communication control node or element, as described above, e.g. (for a communication control node or element, e.g. a gNB) in any one of FIGS. 3 to 6.

For further details regarding the operability/functionality of the apparatuses (or units/means thereof) according to exemplifying embodiments, reference is made to the above description in connection with any one of FIGS. 1 to 6, respectively.

According to exemplifying embodiments of the present disclosure, any one of the (at least one) processor, the (at least one) memory and the (at least one) interface, as well as any one of the illustrated units/means, may be implemented as individual modules, chips, chipsets, circuitries or the like, or one or more of them can be implemented as a common module, chip, chipset, circuitry or the like, respectively.

According to exemplifying embodiments of the present disclosure, a system may comprise any conceivable combination of any depicted or described apparatuses and other network elements or functional entities, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, a basic system architecture of a (tele)communication network including a mobile communication system where some examples of exemplifying embodiments are applicable may include an architecture of one or more communication networks including wireless access network sub-/system(s) and possibly core network(s). Such an architecture may include one or more communication network control elements or functions, such as e.g. access network elements, radio access network elements, access service network gateways or base transceiver stations, like a base station, an access point, a NodeB (NB), an eNB or a gNB, a distributed or a central unit, which controls a respective coverage area or cell(s) and with which one or more communication stations such as communication elements or functions, like user devices or terminal devices, like a UE, or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The general functions and interconnections of the described elements and functions, which also depend on the actual network type, are known to those skilled in the art and described in corresponding specifications, so that a detailed description thereof is omitted herein. It should be appreciated that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of exemplifying embodiments may also be able to communicate with other networks, such as a public switched telephone network or the Internet, including the Internet-of-Things. The communication network may also be able to support the usage of cloud services for virtual network elements or functions thereof, wherein it is to be noted that the virtual network part of the (tele)communication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g. a cloud infrastructure.

Any method step is suitable to be implemented as software or by hardware without changing the idea of the present disclosure. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or units/means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for enabling/realizing pathloss measurement on an unlicensed spectrum, i.e. arrangement of an appropriate pathloss reference signal for operation on an unlicensed spectrum. Such measures exemplarily comprise that a communication node or element in a communication system, which is configured for beam-based operation on an unlicensed band, obtains a pathloss measurement configuration, including a reference signal for pathloss measurement, validates practicability of pathloss measurement based on the configured reference signal, and controls pathloss measurement, wherein pathloss is measured based on the configured reference signal in a case where the configured reference signal is practicable, or pathloss measurement is skipped or pathloss is measured based on another reference signal being on the same quasi-co-location chain as the configured reference signal in a case where the configured reference signal is not practicable.

Even though the present disclosure is described above with reference to the examples according to the accompanying drawings, it is to be understood that the present disclosure is not restricted thereto. Rather, it is apparent to those skilled in the art that the present disclosure can be modified in many ways without departing from the scope of the inventive idea as disclosed herein.

### LIST OF ACRONYMS AND ABBREVIATIONS

| | |
|---|---|
| 3GPP | 3rd Generation Partnership Project |
| 5G | 5^{th} Generation |
| 6G | 6^{th} Generation |
| 7G | 7^{th} Generation |
| BWP | Bandwidth |
| COT | Channel Occupancy Time |
| CSI | Channel State Information |
| CSI-RS | Channel State Information - Reference Signal |
| CU | Central Unit |
| DCI | Downlink Control Information |
| DL | Downlink |
| DMRS | Demodulation Reference Signal |
| DU | Distributed Unit |
| ETSI | European Telecommunications Standards Institute |
| gNB | 5G/6G/7G/NR Node B |
| IAB | Integrated Access and Backhaul |
| LBT | Listen-Before-Talk |
| MAC CE | Medium Access Control - Control Element |
| MT | Mobile Termination |
| NR | New Radio |
| NR-U | New Radio Unlicensed |
| PBCH | Physical Broadcast Channel |
| PDCCH | Physical Downlink Control Channel |
| PDSCH | Physical Downlink Shared Channel |
| PL | Pathloss |
| PSS | Primary Synchronization Signal |
| PUCCH | Physical Uplink Control Channel |
| PUSCH | Physical Uplink Shared Channel |
| QCL | Quasi-Co-Location |

1. A method of a communication node or element in a communication system, which is configured for beam-based operation on an unlicensed spectrum, the method comprising:
obtaining a pathloss measurement configuration, including a reference signal for pathloss measurement;
validating practicability of pathloss measurement based on the configured reference signal; and
controlling pathloss measurement, wherein pathloss is measured based on the configured reference signal in a case where the configured reference signal is practicable, or pathloss measurement is skipped or pathloss is measured based on another reference signal being on the same quasi-co-location chain as the configured reference signal in a case where the configured reference signal is not practicable.

2. The method according to claim 1, wherein validating comprises:
checking presence of the configured reference signal, wherein the configured reference signal is practicable when being present, and/or
checking validity of the configured reference signal, wherein the configured reference signal is practicable when being valid.

3-18. (canceled)

19. A method of a communication control node or element in a communication system, which is configured for beam-based operation on an unlicensed spectrum, the method comprising:
providing a pathloss measurement configuration, including a reference signal for pathloss measurement, for a communication control node or element.

20. The method according to claim 19, further comprising:
providing, for the communication control node or element, a channel occupancy time configuration of the communication control node or element, relating to one or more reference signals.

21-24. (canceled)

25. An apparatus of a communication node or element in a communication system, which is configured for beam-based operation on an unlicensed spectrum, the apparatus comprising:
at least one processor; and
at least one memory including computer program code, wherein the processor, with the at least one memory and the computer program code, is configured to cause the apparatus to perform:
obtaining a pathloss measurement configuration, including a reference signal for pathloss measurement,
validating practicability of pathloss measurement based on the configured reference signal, and
controlling pathloss measurement, wherein pathloss is measured based on the configured reference signal in a case where the configured reference signal is practicable, or pathloss measurement is skipped or pathloss is measured based on another reference signal being on the same quasi-co-location chain as the configured reference signal in a case where the configured reference signal is not practicable.

26. The apparatus according to claim 25, wherein validating comprises:
checking presence of the configured reference signal, wherein the configured reference signal is practicable when being present, and/or
checking validity of the configured reference signal, wherein the configured reference signal is practicable when being valid.

27. The apparatus according to claim 26, wherein checking presence yields that the configured reference signal is present when
an indication is obtained, which indicates that the configured reference signal is part of short control signaling, and/or
an indication is obtained, which indicates that the configured reference signal is within a served beam.

28. The apparatus according to claim 27, wherein the indication, which indicates that the configured reference signal is within the served beam, comprises
an indication, which indicates that at least one reference signal providing a quasi-co-location assumption of a channel occupancy time of a serving communication control node or element is earlier on the same quasi-co-location chain as the configured reference signal or has the same quasi-co-location chain as the configured reference signal.

29. The apparatus according to claim 28, wherein the indication, which indicates that the configured reference signal is within the served beam, is based on
detection of a physical downlink control channel with a demodulation reference signal on the same quasi-co-location chain as the configured reference signal, and/or content of downlink control information on a physical downlink control channel.

30. The apparatus according to claim 29, wherein checking validity yields that the configured reference signal is valid when
the configured reference signal has or relates to a downlink or flexible resource.

31. The apparatus according to claim 25, wherein the processor, with the at least one memory and the computer program code, is configured to cause the apparatus to perform:
obtaining a channel occupancy time configuration of a serving communication control node or element, relating to one or more reference signals, wherein
validating comprises checking correspondence of the configured reference signal with the one or more reference signals, and
the configured reference signal is practicable when corresponding to at least one of the one or more reference signals.

32. The apparatus according to claim 31, wherein the channel occupancy time configuration comprises:
a quasi-co-location assumption of a channel occupancy time of the serving communication control node or element, and/or
an indication of one or more additional reference signals which are spatially correlated with at least one reference signal providing the quasi-co-location assumption.

33. The apparatus according to claim 32, wherein the indicated one or more additional reference signals comprise one or more channel state information reference signals and/or comprise or are contained in one or more blocks of a synchronization signal and/or a physical broadcast channel.

34. The apparatus according to claim 33, wherein checking comprises:
checking whether the configured reference signal is among the one or more reference signals, including the at least one reference signal providing the quasi-co-location assumption and the indicated one or more additional reference signals.

35. The apparatus according to claim 34, wherein, when the configured reference signal is among the one or more reference signals, the pathloss is measured based on the configured reference signal using at least one of:
the at least one reference signal providing the quasi-co-location assumption,
the indicated one or more additional reference signals, and
reference signals sharing the same quasi-co-location assumption in the channel occupancy time of the serving communication control node or element.

36-42. (canceled)

43. An apparatus of a communication control node or element in a communication system, which is configured for beam-based operation on an unlicensed spectrum, the apparatus comprising:
at least one processor; and
at least one memory including computer program code, wherein the processor, with the at least one memory and the computer program code, is configured to cause the apparatus to perform:
providing a pathloss measurement configuration, including a reference signal for pathloss measurement, for a communication control node or element.

44. The apparatus according to claim 43, wherein the processor, with the at least one memory and the computer program code, is configured to cause the apparatus to perform:
providing, for the communication control node or element, a channel occupancy time configuration of the communication control node or element, relating to one or more reference signals.

45. The apparatus according to claim 44, wherein the channel occupancy time configuration comprises:
a quasi-co-location assumption of a channel occupancy time of the communication control node or element, and
an indication of one or more additional reference signals which are spatially correlated with at least one reference signal providing the quasi-co-location assumption.

46. The apparatus according to claim 45, wherein the indicated one or more additional reference signals comprise one or more channel state information reference signals and/or comprise or are contained in one or more blocks of a synchronization signal and/or a physical broadcast channel.

47. The apparatus according to claim 46, wherein the configured reference signal is a channel state information reference signal.

48-49. (canceled)
